(19) United States
(12) Patent Application Publication
(10) Pub. No.: US 2016/0066581 A1
(43) Pub. Date: Mar. 10, 2016

(54) SILVER ION SOLUTION AGRICULTURAL FORMULATIONS

(71) Applicant: Michael N. Young, Wapato, WA (US)

(72) Inventor: Michael N. Young, Wapato, WA (US)

(21) Appl. No.: 14/848,286

(22) Filed: Sep. 8, 2015

Related U.S. Application Data
(60) Provisional application No. 62/047,603, filed on Sep. 8, 2014.

(51) Int. Cl. A01N 59/16; A01N 25/02

(52) U.S. Cl. CPC A01N 59/16; A01N 25/02

(57) ABSTRACT

Silver ion solutions for use in agricultural spray formulations prepared for use in agricultural environs as an effective anti-bacterial spray, without environmentally hazardous or undesirable phytotoxicity. An iodine solution, a lime juice or a cranberry juice adjunct may be added to the silver ion solution in deionized water, to increase efficacy, especially in the ultra-low concentration range of the solution from parts per billion to parts per trillion of silver ion. The organically certifiable silver ion agricultural solution is applied externally to an agricultural commodity in the orchard or field, such as apples, cherries, pears, or any other fruit or vegetable.

### TECHNICAL FIELD

The invention relates to silver ion solutions for use in agricultural spray formulations. Specifically, the solutions prepared according to the present invention can be employed in agricultural environs as an effective anti-bacterial spray, without environmentally hazardous or undesirable phytotoxicity.

### BACKGROUND OF THE INVENTION

Certain preparations of silver containing solutions in potable water are well known to have germicidal related properties. It is purported that certain ancient peoples placed silver shavings and coins in water, for the apparent benefit of keeping the water safe to drink. More specifically, U.S. Pat. No. 7,135,195 discloses the use of silver ions in water solutions of between 4 ppm and 40 ppm, for ingestion by humans to promote health and kill or disable hazardous microorganisms.

No prior formulations are found that expand the use of these disclosed silver ion formulations beyond the human medicinal applications. Therefore, a method of silver ion solution use is needed, enabling the use of these solutions beyond internal human use, without toxic or environmentally hazardous effects or components.

The following is a disclosure of the present invention that will be understood by reference to the following detailed description.

### DETAILED DESCRIPTION OF SPECIFIC EMBODIMENTS

The present invention provides agricultural formulations of a silver ion solution in water. Specifically, the silver ion solutions formulated and applied according to the present invention can be employed in an agricultural environ as an effective anti-bacterial spray, without environmentally hazardous or undesirable phytotoxicity to the treated vegetation.

Specifically, the invention comprises an ultra-diluted solution of a silver ion in water at a concentration that was heretofore undisclosed, being that such low concentrations were considered ineffective as anti-bacterial formulations. Additionally, the ultra-diluted solution of the silver ion in water applied in accordance to the present invention is expected to be effective as an agricultural spray when applied to crops, including tree fruits and vegetation, without undesirable phytotoxic reactions.

“Fire blight” is a destructive disease affecting pome fruit trees (pear and apple). The cause of file blight is the bacterium Erwinia amylovora. Similarly, “bacterial canker” in tree fruit crops is a destructive and costly disease that affects a significant portion of the trees and fruit in commercially harvested varieties of pome fruits and stone fruits, especially apples, cherries and pears. The cause of bacterial canker is the bacterium Pseudomonas syringae. Symptoms of bacterial canker in cherries include sunken, dark areas of unhealthy tissue along the trunks and larger branches, which significantly reduces the bloom and fruit bearing ability of the tree.

No prior known formulations expand the use of silver ion formulations into the field of bacterial control and eradication on agricultural produce. Most importantly, no information on external application to vegetation tissues is known, related to the potential efficacy of such solutions on bacterial disease in agricultural crops and produce.

For the present invention, it was discovered that effective concentration of silver ions in a water solution could be far less than the concentrations reported to have a beneficial effect after internal human consumption of the solution. Specifically, U.S. Pat. No. 7,135,195 discloses the use of silver ions in water solutions of between 4 ppm and 40 ppm, for ingestion by humans, to promote health and kill or disable hazardous microorganisms. After laboratory bench tests employing cultures of Erwinia amylovora treated with successively dilute silver ion solutions in water, it was found that concentrations up to one-billion-to-one (1 ppb), and potentially up to one-trillion-to-one (1 ppt) of the silver ion were effective in killing the agricultural bacterium. This ultra-dilute efficacy is remarkable. Agricultural bactericidal success at such low concentrations of a solution previously only considered effective in internally ingested dosages for humans, was unexpected.

The silver ion solution in its dilute but effective formulation could be mixed and applied onto an agricultural commodity, such as an orchard or row crop. This spray application could be achieved with any conventional equipment, such as a tank sprayer, and follow the typical procedures for bactericide spray regimens. For orchard fruit, a critical time for bacterial control is during the bloom period. A suggested timing for spraying the silver ion solution in an orchard in accordance to the present invention, would be shortly before tree fruit bloom (approximately up to two-days), and spraying after petal fall. Additionally, the silver ion solution could be applied just before or immediately after rain or damaging hail, or at any time during the growing period, as typically desired for optimal bacterial control. It is conceived that conventional spraying practices as well known by those skilled in agricultural sprays can be followed for agricultural use of the silver solutions prepared at the effective dilutions and formulations described herein.

In addition, it is expected that the agricultural formulations of a silver ion solution will be effective for controlling the growth of bacterial strains that afflict tree and row crops, including stone fruit, pome fruit, vine fruits, vegetables and row crops in general. These common bacterium include, but are not limited to:

Pseudomonas syringae (attributable to causing: Bacterial blight, Varnish spot, Angular leaf spot, Peppery leaf spot, Halo blight, and Bacterial brown spot);
Clavibacter michiganensis (attributable to causing: Bacterial canker);
Xanthomonas campestris (attributable to causing: Bacterial leaf spot or simply “Bacterial spot”);
Pseudomonas Erwinia (attributable to causing: Fire blight and Bacterial soft rot);
Ralstonia solanacearum (attributable to causing: Bacterial wilt);
Xanthomonas campestris (attributable to causing: Black rot);
Rhizomonas suberifaciens (attributable to causing: Corky root);
Pseudomonas corrugata (attributable to causing: Bacterial pith necrosis);
Xanthomonas campestris (attributable to causing: Common bacterial blight); and
Erwinia carotovora (attributable to causing: Black leg).

The following examples were performed to test the efficacy of the silver ion solution for agricultural prevalent bacterium. From the results of these examples, it expected that spray applications of the silver solutions in a novel dilute and ultra-dilute concentrations would be effective to control bacterial outbreaks in agricultural settings.

### EXAMPLE 1

The following Table 1 lists the silver solution dilutions and observed results when the solutions were introduced into a fire blight bacteria (Erwinia amylovora, strain 153) culture. The wild type (native) Erwinia amylovora, strain 153, is indigenous to Oregon and was originally isolated from an apple orchard there in 1990. It has been widely studied and used in experimental trials. Its virulence is typical of other indigenous Erwinia amylovora strains in the U.S. This first laboratory example documents the treatment of a bacterial culture with varied concentrations of the silver ion solution in water. The Erwinia amylovora, strain 153 bacterial culture was grown in a standard polystyrene Petri type dish containing a sterile agar, and then inoculated with Erwinia amylovora, strain 153. For the purpose of this and the following examples that employ the sterile agar, the agar media includes a yeast, a nutrient broth and dextrose. A “Standard Nutrient Agar” was used for this example, as approved by the New York State Agricultural Experiment Station, as well know to those persons skilled in the preparation of agars for bacteria culture, and as is typically used as a general utility medium for cultivation and enumeration of not particularly fastidious microorganisms. The listed visual observations were performed by visual inspection of the sample, approximately 24 hours after incubating the silver solution inoculated culture at a temperature varying between approximately 70 to 76 degrees F., over the 24-hour period.

The preferred 1:1 starting concentration of the silver ion solution for use in the present invention has a silver concentration listed at 10 ppm. The preferred “off the shelf” silver ion solution is provided in solution with a deionized water, as manufactured by American Biotec Labs, LLC, of Alpine Utah, and marketed under the trade name SILVER BIOTICS®, the production of which is described in U.S. Pat. Nos. 6,214,299 and 6,743,348. The SILVER BIOTICS® product is prescribed to be taken internally, and purported to boost the human immune system, as discussed in U.S. Pat. No. 7,135,195.

Additionally, the term “approximately” is used herein to refer to a range of values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produce equivalent results to those described herein.

TABLE 1
Silver Ion Solution Observed Efficacy on Erwinia amylovora,
Strain 153 Culture

| Initial | | | 24 hr |
|---|---|---|---|
| Concentration | Dilution | Resultant Concentration | Observation |
| 10 ppm | 1:1 × 10−4 | 1 part per billion (ppb) | Positive |
| 10 ppm | 1:3 × 10−4 | 3 part per billion (ppb) | Positive |
| 10 ppm | 1:1 × 10−7 | 1 part per trillion (ppt) | Negative |

### EXAMPLE 2

The following Table 2 lists the silver solution dilutions and observed results when the solutions were again introduced into the fire blight bacteria (Erwinia amylovora, strain 153) culture. This second laboratory example documents the treatment of the bacterial culture with varied concentrations of the silver ion solution in water. Again, the Erwinia amylovora, strain 153 bacterial culture was grown in a standard polystyrene Petri dish containing the sterile agar, which was then inoculated with Erwinia amylovora, strain 153. The agar media included a yeast, a nutrient broth and dextrose. As with Example 1, above, the listed visual observations were performed by visual inspection of the sample, approximately 24 hours after incubating the silver solution inoculated culture at a temperature varying between approximately 70 to 76 degrees F., over the 24 hour period.

Again, the preferred 1:1 starting concentration of the silver ion solution for use in the present invention has a silver concentration of 10 ppm. Again, the preferred silver ion standard solution for use with the present invention is a 10 ppm silver ion solution in a deionized water, as manufactured by American Biotec Labs, LLC, of Alpine Utah, and marketed under the trade name SILVER BIOTICS®. Successive dilutions of the standard solution were made to arrive at a 1 ppm (part per million) silver solution, a 1 ppb (part per billion) silver solution, and a 1 ppt (part per trillion) silver solution.

TABLE 2
Silver Ion Solution Observed Efficacy on Erwinia amylovora,
Strain 153 Culture

| Dilution | Silver Concentration | Observation |
|---|---|---|
| 1:0.1 (or 10⁻¹) | 1.0 ppm | Strong Positive |
| 1:0.0001 (or 10⁻⁴) | 1.0 ppb | Positive |
| 1:0.00000001 (or 10⁻⁷) | 1.0 ppt | Weak Positive |

### EXAMPLE 3

The following Table 3 lists the silver solution dilutions and observed results when the dilute solutions were introduced directly into a water solution of fire blight bacteria (Erwinia amylovora, strain 153). This third laboratory example documents the subjective treatment of the bacterial solution in a sterile broth with varied concentrations of the silver ion solution in water. Two dilutions were made, to 10 ppb (parts per billion) and 30 ppb. The sterile broth included yeast, nutrients and dextrose. The resultant broth was then inoculated with the Erwinia amylovora, strain 153 bacteria and incubated under laboratory conditions, resulting in a cloudy mixture having a yellow hue. For this example, 180 microliters of the broth was mixed with 20 microliters of the silver solution at three levels of dilution in deionized water, including one containing only deionized water as a control. The below listed observations of the small aliquot container tubes of the solutions were made approximately 24 hours after adding the listed concentrations of silver ion contacting solution and incubating the silver solution inoculated liquid cultures at a temperature varying between approximately 70 to 76 degrees F.

TABLE 3
Silver Ion Solution Observed Efficacy on a Erwinia amylovora,
Strain 153 Liquid Broth

| ppm Silver Solution | Observation |
|---|---|
| 0.0 (control) | Yellow-Negative |
| 10 ppb | Light Yellow-Positive |
| 30 ppb | Clear-Strong Positive |

### EXAMPLE 4

The following Table 4 lists additional silver solution dilutions and observed results when the solutions were introduced into a solution of fire blight bacteria (Erwinia amylovora, strain 153). This fourth laboratory example documents additional subjective treatment of the bacterial solution in a broth with varied concentrations of the silver ion solution in water. Again, the broth included yeast, nutrients and dextrose. The resultant broth was then inoculated with the Erwinia amylovora, strain 153 bacteria and incubated under laboratory conditions, resulting in a cloudy mixture having a yellow hue. For this example, 80 microliters of the broth was mixed with 20 microliters of the silver solution at six levels of dilution in deionized water, including one containing only deionized water as a control. The below listed observations of the small aliquot container tubes of the solutions were made approximately 24 hours after adding the listed concentrations of silver ion contacting solution and incubating the silver solution inoculated liquid cultures at a temperature varying between approximately 70 to 76 degrees F.

TABLE 4
Silver Ion Solution Observed Efficacy on a Erwinia amylovora,
Strain 153 Liquid Broth

| ppm Silver | Observation | Efficacy |
|---|---|---|
| 0.0 (control) | Cloudy Yellow | Negative |
| 30 | Pale Clear Yellow | Strong Positive |
| 3.0 | Pale Clear Yellow | Strong Positive |
| 0.3 | Pale Clear Yellow | Strong Positive |
| 0.03 | Pale Dull Yellow | Weak Positive |
| 0.003 | Pale Clear Lt. Yellow | Positive |

### EXAMPLE 5

The following Table 5 lists additional silver solution dilutions and observed results when the solutions were introduced into a solution of fire blight bacteria (Erwinia amylovora, strain 153). This fifth laboratory example documents additional subjective treatment of the bacterial solution in a broth with varied concentrations of the silver ion solution in water. Again, the broth included yeast, nutrients and dextrose. The resultant broth was then inoculated with the Erwinia amylovora, strain 153 bacteria and incubated under laboratory conditions, resulting in a cloudy mixture having a yellow hue. For this example, 240 microliters of the broth was mixed with 60 microliters of the silver solution in standard centrifuge tubes at four levels of dilution in deionized water, including one containing only deionized water as a control. The below listed observations of the small aliquot container tubes of the solutions were made approximately 24 hours after adding the listed concentrations of silver ion contacting solution and incubating the silver solution inoculated liquid cultures at a varying between approximately 70 to 76 degrees F.

TABLE 5
Silver Ion Solution Observed Efficacy on a Erwinia amylovora,
Strain 153 Liquid Broth

| ppm Silver | Observation | Efficacy |
|---|---|---|
| 0.0 (control) | Cloudy Yellow | Negative |
| 1.0 | Pale Clear Yellow | Strong Positive |
| 0.1 | Pale Clear Yellow | Strong Positive |
| 0.01 | Pale Clear Yellow | Strong Positive |
| 0.001 | Pale Yellow | Positive |

### EXAMPLE 6

To observe potential phytotoxic effects of silver formulations on plant tissue, a commercially available 24 ppm silver concentration ointment marketed as SilverGel™, and also manufactured by American Biotec Labs, LLC, of Alpine Utah, was applied to the leaves and fruit of an apple tree and monitored over a six day period. The timing of this test example was pre-harvest, at Wapato, Wash., with typical fruit temperature and sun exposure for August. No phytotoxic effects were observable.

### EXAMPLE 7

The following Table 7 lists ultra-dilute silver solutions mixed with selected carriers or adjuvants, and the observed results when the resultant mixtures were introduced into a Petri dish containing a sterile agar, then inoculated with Erwinia amylovora fire blight bacteria (Erwinia amylovora, strain 153). The agar media initially included a yeast, a nutrient broth and dextrose, as detailed in Example 1, above. The below listed visual observations were performed by visual inspection of the sample, approximately 24 hours after incubating the silver solution inoculated culture at a temperature varying between approximately 70 to 76 degrees F., over the 24 hour period.

The preferred silver ion solution for use in the present invention has a resultant silver concentration of 10 ppt (parts per trillion). Again, the preferred silver ion standard solution for use with the present invention is a 10 ppm silver ion solution in a deionized water, as manufactured by American Biotec Labs, LLC, of Alpine Utah, and marketed under the trade name SILVER BIOTICS®. Successive dilutions of the standard solution in a triple-distilled water deionized water were made to arrive at a 10 ppt (part per trillion) silver solution, which corresponds to a 1×10⁻⁵ ppm silver solution.

TABLE 7
First Set of Silver Ion Solution Mixtures Observed Efficacy on
Erwinia amylovora Culture

| ppt Silver | Adjuvant | Observation | Efficacy |
|---|---|---|---|
| 0 | Water (control) | Circular, Creamy | Negative |
| | | Translucent Colony | |
| 10 | Graviola | Circular, Creamy | Negative |
| | | Translucent Colony | |
| 10 | Cranberry | No Colony Growth | Strong Positive |
| 10 | Iodine Tincture | No Colony Growth | Strong Positive |
| 10 | Lime Juice | No Colony Growth | Strong Positive |
| 10 | Garlic Oil | Circular, Creamy | Negative |
| | | Translucent Colony | |
| 10 | Alfalfa Oil | Circular, Creamy | Negative |
| | | Translucent Colony | |

The agar media employed in Example 7 is as detailed in Example 1, above. A purified water alone, without any silver solution added was employed as a control. The water was a commercially available, triple distilled and super-filtered water, suitable for laboratory use. For each listed adjuvant, 100 microliters (100 μl or 10⁻⁴ liters) of the particular adjuvant were mixed with 100 micro-liters of the agar media and 100 micro-liters of the 10 ppt silver solution, for a resultant silver concentration in the Petri dish when mixed with the agar media and the selected adjuvant, of approximately 3.3 ppt.

For the above Adjuvants, listed in Table 7, the following descriptions apply: The Graviola is a commercially available 100% pure extract of the graviola fruit (Annona muricata), indigenous to South America. The Cranberry is a commercially available 100% pure juice of cranberries. The Iodine Tincture is a commercially available and conventionally defined “Iodine Tinctrue USP” or “2% free iodine tincture solution,” and contains approximately 1.8 grams to 2.2 grams of elemental iodine and approximately 2.1 grams to 2.6 grams of sodium iodide in each 100 mL of solution, of which 50 ml is ethyl-alcohol is and the balance is purified water. This 2% free iodine tincture solution provides about one mg of free iodine, per drop of solution. The Lime Juice is a commercially available 100% pure juice of limes. The Garlic Oil is commercially available 100% pure, therapeutic grade of essential oil of garlic. The Alfalfa Oil is also commercially available 100% pure, therapeutic grade of oil of alfalfa.

The “Negative” listed results in Table 7, are defined as occurring when the Erwinia amylovora fire blight bacteria inoculated to the Petri dish with appeared to thrive and resulted in the growth of at least one circular colony of bacterium. The colonies were translucent to the light passing though the cultures, and had a slightly creamy color. The “Strongly Positive” results occurred when no colonies were observable after the inoculation of the Petri dish with Erwinia amylovora fire blight bacteria, and the incubation period had passed.

As listed in Table 7, above, the Cranberry, Iodine Tincture, Olive Leaf and Lime Juice adjuvant as exhibited strongly positive efficacy in suppressing bacterial growth. To better quantify and confirm this initial finding, Example 8 was performed, as follows.

### EXAMPLE 8

The following Table 8 details of the ultra-dilute silver solutions, again mixed with selected carriers or adjuvants, and the observed results when the resultant mixtures were introduced into a Petri dish containing a sterile agar, then inoculated with Erwinia amylovora fire blight bacteria (Erwinia amylovora, strain 153). The agar media initially included a yeast, a nutrient broth and dextrose, as detailed in Example 1, above. The below listed visual observations were performed by visual inspection of the sample, approximately 24 hours after incubating the silver solution inoculated culture at a temperature varying between approximately 70 to 76 degrees F., over the 24 hour period.

The preferred silver ion solution for use in the present invention has a resultant silver concentration of approximately 10 ppt (parts per trillion). Again, the preferred silver ion standard solution for use with the present invention is a 10 ppm silver ion solution in a deionized water, as manufactured by American Biotec Labs, LLC, of Alpine Utah, and marketed under the trade name SILVER BIOTICS®. Successive dilutions of the standard solution in a triple-distilled water deionized water were made to arrive at a 10 ppt (part per trillion) silver solution, which corresponds to a 1×10⁻⁵ ppm solution.

TABLE 8
Second Set of Silver Ion Solution Mixtures Observed Efficacy
on Erwinia amylovora Culture

| ppt Silver | Adjuvant | Observation | Efficacy |
|---|---|---|---|
| 0 | Water (control) | Circular Translucent- | Negative |
| | | Cream Colony | |
| 10 | Water | Circular Translucent- | Negative |
| | | Cream Colony | |
| 10 | Iodine Tincture | No Colony Growth | Strongly Positive |
| 10 | Lime Juice | No Colony Growth | Strongly Positive |
| 10 | Cranberry | No Colony Growth | Strongly Positive |

The agar media employed in Example 8 is as detailed in Example 1, above. A purified water alone, without any silver solution added was employed as a control. The water was a commercially available, triple distilled and super-filtered water, suitable for laboratory use. For each listed adjuvant, 100 micro-liters (100 μl or 10⁻⁴ liters) of the particular adjuvant were mixed with 100 micro-liters of the agar media and 100 micro-liters of the 10 ppt silver solution, for a resultant silver concentration in the Petri dish when mixed with the agar media and the selected adjuvant, of approximately 3.3 ppt.

For the above Adjuvants, listed in Table 8, the following descriptions apply: The Water was a commercially available, triple distilled and super-filtered water, suitable for laboratory use. The Cranberry is a commercially available 100% pure juice of cranberries. The Iodine Tincture is a commercially available and conventionally defined “Iodine Tinctrue USP” or “2% free iodine tincture solution,” and contains approximately 1.8 grams to 2.2 grams of elemental iodine and approximately 2.1 grams to 2.6 grams of sodium iodide in each 100 mL of solution, of which 50 ml is ethyl-alcohol is and the balance is purified water. This 2% free iodine tincture solution provides about one mg of free iodine, per drop of solution. The Lime Juice is a commercially available 100% pure juice of limes. The Garlic Oil is commercially available 100% pure, therapeutic grade of essential oil of garlic. The Alfalfa Oil is also commercially available 100% pure, therapeutic grade of oil of alfalfa.

The “Negative” listed results in Table 8, are defined as occurring when the Erwinia amylovora fire blight bacteria inoculated to the Petri dish with appeared to thrive and resulted in the growth of at least one circular colony of bacterium. The colonies were translucent to the light passing though the cultures, and had a slightly creamy color. The “Strongly Positive” results occurred when no colonies were observable after the inoculation of the Petri dish with Erwinia amylovora fire blight bacteria, and the incubation period had passed.

The above eight examples verify the efficacy of the silver ion solution for agricultural prevalent bacterium. From the results of these examples, it expected that spray applications of the silver solutions in a novel dilute and ultra-dilute concentrations would be effective to control bacterial outbreaks in agricultural settings. Especially effective are the ultra-dilute formulations of silver ion solution and the iodine tincture, or lime juice or cranberry juice adjuvants. It is observed that the ultra dilute concentration of the silver ion is enhanced or amplified by the presence of these specific adjuvants. This enhancement was unexpected and only found through the performance of the above experiments. The ultra-low application of the silver ion solution for agricultural prevalent bacterium, in combination with the specific adjuvants found herein, will likely be a boon to the production of agricultural commodities, such as tree crops, fruits and vegetables, and most especially in the production of organic certified produce.

Specifically, a mixture of concentrated silver ion solution and de-ionized water, with the resultant silver ion concentration between 10 parts per billion and 0.1 parts per trillion in the final agricultural solution. To enhance the activity of the silver ion in solution, an adjunct is preferably added to the silver ion solution, being an iodine solution, a lime juice or a cranberry juice. Again, the silver ion agricultural solution is applied externally to an agricultural commodity, and very effective in preventing the growth of bacterium on the agricultural commodity.

Again, no prior formulations propose to use of silver ion formulations for bacterial control and eradication on agricultural produce, as detailed herein. Most importantly, no information on external application to vegetation tissues is available, related to the potential efficacy of such solutions on bacterial disease in agricultural crops and produce.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A silver ion agricultural solution in water comprising:
a silver ion in solution with a water, the silver ion having a silver ion concentration between 1.0 parts per million and 1.0 parts per billion; and
the silver ion in solution with the water applied as an agricultural spray.

2. A silver ion agricultural solution comprising:
a mixture of a concentrated silver ion solution and a de-ionized water;
the silver ion having a silver ion concentration in the silver ion agricultural solution between 1.0 parts per million and 1.0 parts per billion; and
the silver ion agricultural solution applied externally to an agricultural commodity.

3. The silver ion agricultural solution of claim 2, wherein:
the silver ion agricultural solution is effective to prevent the growth of a bacterium on the agricultural commodity.

4. The silver ion agricultural solution of claim 2, additionally comprising:
an adjunct selected from the group consisting of an iodine solution, a lime juice and a cranberry juice.

5. The silver ion agricultural solution of claim 4, wherein:
the iodine solution comprises a solution of approximately 2% free iodine.

6. The silver ion agricultural solution of claim 5, wherein:
the iodine solution contains approximately 1.8 to 2.2 grams of an elemental iodine and approximately 2.1 to 2.6 grams of a sodium iodide in each 100 mL of the iodine solution, of which approximately 50 ml of the iodine solution is an ethyl-alcohol, and the balance of the iodine solution is a purified water.

7. The silver ion agricultural solution of claim 4, wherein:
the lime juice is a commercially available and an approximately 100% pure juice of a lime.

8. The silver ion agricultural solution of claim 4, wherein:
the cranberry juice is a commercially available and an approximately 100% pure juice of a cranberry.

9. The silver ion agricultural solution of claim 2, wherein:
the agricultural commodity is an organic certified produce.

10. A silver ion agricultural solution comprising:
a mixture of a concentrated silver ion solution and a de-ionized water;
the silver ion agricultural solution having a silver ion concentration between 10 parts per billion and 0.1 parts per trillion;
an adjunct selected from the group consisting of an iodine solution, a lime juice and a cranberry juice; and
the silver ion agricultural solution is applied externally to an agricultural commodity.

11. The silver ion agricultural solution of claim 10, wherein:
the iodine solution comprises a solution of approximately 2% free iodine.

12. The silver ion agricultural solution of claim 11, wherein:
the iodine solution contains approximately 1.8 to 2.2 grams of an elemental iodine and approximately 2.1 to 2.6 grams of a sodium iodide in each 100 mL of the iodine solution, of which approximately 50 ml of the iodine solution is an ethyl-alcohol, and the balance of the iodine solution is a purified water.

13. The silver ion agricultural solution of claim 10, wherein:
the lime juice is a commercially available and an approximately 100% pure juice of a lime.

14. The silver ion agricultural solution of claim 10, wherein:
the cranberry juice is a commercially available and an approximately 100% pure juice of a cranberry.

15. The silver ion agricultural solution of claim 10, wherein:
the silver ion agricultural solution is effective to prevent the growth of a bacterium on the agricultural commodity.

16. The silver ion agricultural solution of claim 10, wherein:
the agricultural commodity is an organic certified produce.
